(19) United States
(12) Patent Application Publication
(10) Pub. No.: US 2026/0241797 A1
(43) Pub. Date: Aug. 20, 2026

(54) Method and System for Controlling a Vehicle Display

(71) Applicant: Bayerische Motoren Werke Aktiengesellschaft, Muenchen (DE)

(72) Inventors: Mathias Ordung, Muenchen (DE); Constanze Althammer, Holzkirchen (DE)

(21) Appl. No.: 19/164,961

(22) PCT Filed: Jan. 31, 2024
(86) PCT No.: PCT/EP2024/052378

§ 371 Date: Sep. 12, 2025

(30) Foreign Application Priority Data
Mar. 20, 2023 (DE) 10 2023 106 852.0

(51) Int. Cl. B60K 35/81; B60K 35/28; G06V 20/59; G06V 40/18

(52) U.S. Cl. CPC B60K 35/81; B60K 35/28; G06V 20/59; G06V 40/18; B60K 2360/11; B60K 2360/149; B60K 2360/1868

(57) ABSTRACT

A method for controlling the display duration of a proactive message on a display device of a vehicle is disclosed herein. The method includes receiving a trigger event from the vehicle to provide the proactive message to a user of the vehicle, and providing the proactive message on the display device of the vehicle to the user of the vehicle. The method further comprises detecting the gaze direction of the user of the vehicle by an interior camera of the vehicle after the proactive message is provided on the display device of the vehicle. When the detected gaze direction of the user is pointing towards a position of the proactive message on the display device of the vehicle, an expiry presentation of the provided proactive message is activated, and the provided proactive message is removed on the display device after the expiry presentation of the provided proactive message has expired.

### CROSS-REFERENCE TO RELATED APPLICATIONS

The present application is the U.S. national phase of PCT Application PCT/EP2024/052378 filed on Jan. 31, 2024, which claims priority of German patent application No. 10 2023 106 852.0 filed on Mar. 20, 2023, the entire contents of which are incorporated by reference herein.

### FIELD

The present disclosure relates to vehicle displays and particularly to a method and system for controlling the display duration of a proactive message on a display device of a vehicle.

### BACKGROUND

Pop-up windows used in vehicles to display suggestions to a user of a vehicle are known from the prior art. A user of the vehicle must actively perform a touch operation and/or operate a physical operating control of the vehicle in order to close pop-up windows containing the suggestion. This leads to low user acceptance of pop-up windows on a display in a vehicle.

Therefore, it would be advantageous to efficiently improve providing a proactive message in a vehicle. In particular, it would be advantageous to efficiently control the display duration of a proactive message in a vehicle.

### SUMMARY

According to a first aspect, a method is disclosed for controlling the display duration of a proactive message on a display device of a vehicle. The method can be a computer-implemented method and/or a method implemented by a control unit. A display device of a vehicle can be a display, a touch-sensitive display, and/or a head-up display of a vehicle. The method comprises receiving a trigger event from the vehicle for providing the proactive message to a user of the vehicle, and providing the proactive message on the display device of the vehicle to the user of the vehicle. The method further comprises detecting the gaze direction of the user of the vehicle by an interior camera of the vehicle after the proactive message is provided on the display device of the vehicle. If the detected gaze direction of the user is pointing towards a position of the proactive message on the display device of the vehicle, the method activates an expiry presentation of the provided proactive message, and the method removes the provided proactive message on the display device after the expiry presentation of the provided proactive message has expired.

Advantageously, the display duration of the proactive message can be controlled efficiently by a look from the user. The user of the vehicle is not distracted by searching for an operating function for removing the proactive message. A single look from the user of the vehicle towards the proactive message can be enough to remove the proactive message from the display device in an automated manner. This can efficiently increase the acceptance by a user to the providing of one or more proactive messages.

According to an advantageous embodiment, the proactive message can be provided in a pop-up element and/or a pop-up window of a graphical user interface on the display device of the vehicle. As a result, the display duration of the pop-up window can be controlled efficiently. The acceptance of a pop-up window for providing proactive messages to a user of a vehicle can be improved efficiently.

According to a further advantageous embodiment, the method can further comprise determining a display validity of the provided proactive message, and removing the provided proactive message on the display device after the display validity of the provided proactive message has expired, if the detected gaze direction of the user is not pointing towards the position of the provided proactive message on the display device of the vehicle. As a result, the provided proactive message can be removed efficiently in an automated manner if the user is not looking towards the provided proactive message.

According to a further advantageous embodiment, the method can further, if the detected gaze direction of the user is pointing towards a position of the proactive message on the display device of the vehicle, determining a display validity of the provided proactive message before activating an expiry presentation, activating the expiry presentation f the provided proactive message before the display validity of the provided proactive message has expired, and removing the provided proactive message on the display device after the expiry presentation of the provided proactive message has expired, even if the display validity of the provided proactive message expired after the activation of the expiry presentation. As a result, removing the proactive message in a manner that is transparent to the user can be implemented efficiently.

According to a further advantageous embodiment, the provided proactive message can comprise a prompt to the user for user interaction or user input, and/or the user interaction and/or the user input by the user can be made as long as the provided proactive message is displayed on the display device. As a result, the user can interact efficiently with the provided proactive message.

According to a further advantageous embodiment, the expiry presentation can comprise a specified timespan, and once it has elapsed, the provided proactive message on the display device is removed in an automated manner. As a result, the proactive message can be removed efficiently.

According to a further advantageous embodiment, the expiry presentation can comprise a preferably animated graphical element, which displays visually or audio-visually the specified timespan and/or the elapsing of the specified timespan, and the expiry presentation can be displayed preferably in the pop-up element and/or the pop-up window of the provided proactive message. As a result, the expiry presentation can be provided efficiently to a user of the vehicle.

According to a further advantageous embodiment, the expiry presentation can be provided in the gaze direction of the user of the vehicle and separately from the position of the provided proactive message on the display device of the vehicle. As a result, the expiry presentation can be provided efficiently to a user of the vehicle.

According to a further advantageous embodiment, the proactive message can be a time-critical message to the user of the vehicle from an intelligent digital assistant of the vehicle. As a result, time-critical messages can be provided efficiently to the user of the vehicle.

According to a further advantageous embodiment, the provided proactive message can be representative of a notification about a current availability of a vehicle function and/or of a driver assistance function of the vehicle, and/or the display validity of the provided proactive message can be representative of the current availability of the vehicle function and/or of the driver assistance function of the vehicle. As a result, a time-dependent proactive message can be provided to a user of the vehicle and removed again efficiently.

According to a further aspect, a computer-readable medium is disclosed for controlling the display duration of a proactive message on a display device of a vehicle, wherein the computer-readable medium comprises instructions which, when executed on a computer and/or a control unit, perform the method described above.

According to a further aspect, a system is disclosed for controlling the display duration of a proactive message on a display device of a vehicle, wherein the system is designed to perform the method described above.

According to a further aspect, a vehicle comprises the above-described system for controlling the display duration of a proactive message on a display device of a vehicle.

The claims, the figures and the description of the figures contain further features of the disclosure. All the features and combinations of features mentioned in the description above and the features and combinations of features mentioned below in the description of the figures and/or shown in the figures alone can be used not only in the respectively stated combination, but also in other combinations or alone.

### BRIEF DESCRIPTION OF THE DRAWINGS

One or more exemplary embodiments of the disclosure is described below with reference to the accompanying drawings, from which can be obtained further details, embodiments and developments of the disclosure, and in which:

FIG. 1 shows schematically an example of a method for controlling the display duration of a proactive message on a display device of a vehicle; and

FIG. 2 shows schematically an example of a graphical user interface of a vehicle with a proactive message.

### DESCRIPTION

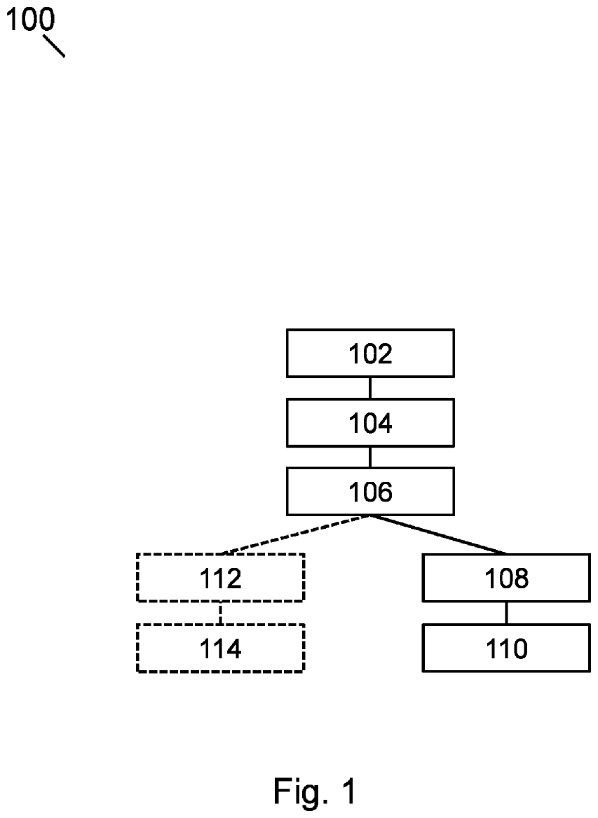

FIG. 1 shows in detail a method 100 for controlling the display duration of a proactive message on a display device or a display control device of a vehicle.

The method 100 can receive 102 a trigger event from the vehicle to provide the proactive message to a user of the vehicle. The trigger event can be triggered by a digital assistant, for example an intelligent digital voice assistant, of the vehicle. The trigger event can depend on a current vehicle context, a current driving situation, and/or a vehicle function, for example a driver assistance function. The proactive message can be a time-dependent and/or time-critical message, which can be triggered proactively by the digital assistant and provided to a user of the vehicle, for example a driver of the vehicle. The proactive message can comprise a recommendation. For example, the proactive message can comprise a recommendation for a driver assistance function that is available to the driver in a current driving situation and can assist him in addressing the driving situation. For example, the proactive message can comprise a recommendation for an unused vehicle function which in a current vehicle context can make it easier for a user of the vehicle to operate the vehicle and/or can increase the convenience for the user of the vehicle. The proactive message is preferably time dependent and/or time critical. If, for example, the current driving situation and/or the current vehicle context changes, the proactive message may no longer be of use to the user of the vehicle. The proactive message can have a display validity.

For example, the display validity can depend on the driving situation and/or the current context. For example, the display validity can depend on a vehicle function and/or a driver assistance function linked to the proactive message. For example, the display validity can be dependent on a skill of the digital assistant, which skill has initiated the trigger event.

The method 100 can provide 104 the proactive message on the display device of the vehicle to the user of the vehicle. The proactive message is preferably provided in a pop-up element and/or a pop-up window of a graphical user interface on the display device of the vehicle. The pop-up element and/or the pop-up window can be provided on the display device of the vehicle in a field of view, in particular a peripheral field of view, of the user, in particular the driver, of the vehicle. A position of the pop-up element or of the pop-up window can be fixed on the graphical user interface. For example, the position of the pop-up element or of the pop-up window can be located on a central information display or a central and/or centrally mounted head-up display.

The method 100 can detect 106 the gaze direction of the user of the vehicle by an interior camera of the vehicle after the proactive message is provided on the display device of the vehicle. For example, the interior camera can be a camera for monitoring the driver of the vehicle. The interior camera can comprise a camera in the visual spectrum and/or a camera in the infrared spectrum. The interior camera can comprise a single camera or an interior camera system composed of a plurality of cameras, which are arranged in the interior of the vehicle.

If the detected gaze direction of the user is pointing towards a position of the proactive message on the display device of the vehicle, the method can activate 108 an expiry presentation of the provided proactive message, and remove 110 the provided proactive message on the display device after the expiry presentation of the provided proactive message has expired. The gaze direction of the user can be detected towards a position or a region of a pop-up element or of a pop-up window comprising the proactive message. The aforementioned steps can be carried out additionally or alternatively if the gaze direction of the user is pointing towards the position or the region of the pop-up element or of the pop-up window comprising the proactive message. The expiry presentation can comprise a visual representation of an elapsing time, which is displayed in the pop-up element or the pop-up window of the provided proactive message and/or separately from the pop-up element and/or pop-up window of the provided proactive message. A look by the user with a gaze direction towards the position of the proactive message can be a look that is held on the proactive message, for example a look that maintains the gaze direction towards the position of the proactive message for a specified minimum timespan. This can prevent an expiry presentation being activated inadvertently by, for example, a glancing look by the user of the vehicle.

If the detected gaze direction of the user is not pointing towards the position of the provided proactive message on the display device of the vehicle, the method 100 can determine 112 a display validity of the provided proactive message, and remove 114 the provided proactive message on the display device after the display validity of the provided proactive message has expired.

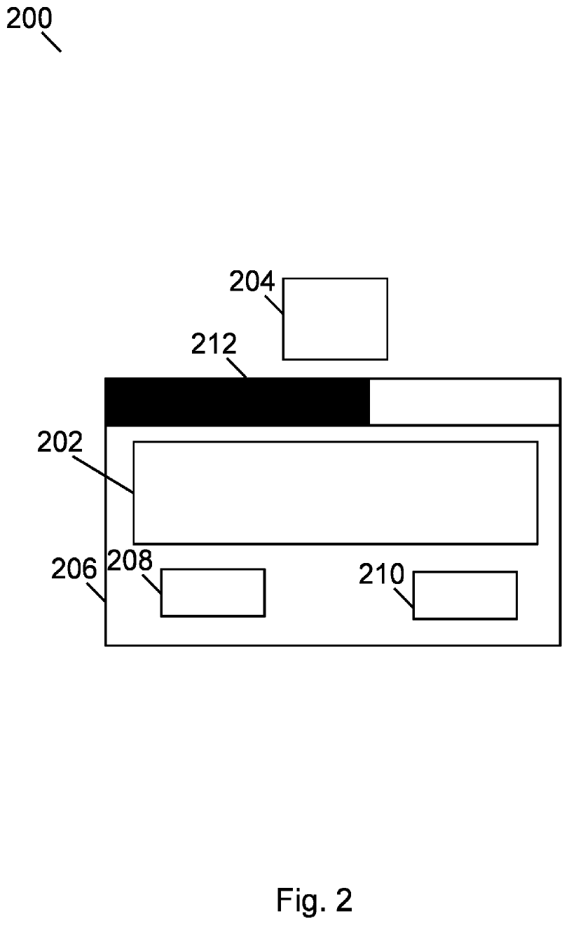

FIG. 2 shows in detail an example of a graphical user interface 200 of a vehicle with a proactive message 202 from a digital voice assistant of the vehicle. The digital voice assistant can comprise a visual representation 204, which is displayed on graphical user interface 200. The proactive message can be provided in a pop-up window 206. The pop-up window 206 of the proactive message can be positioned and displayed near the position of the graphical representation 204 of the digital voice assistant. The pop-up window 206 can have one or more buttons 208, 210, which allow user interaction with the user of the vehicle. If the gaze direction of the user is pointing towards the pop-up window and/or the proactive message of the pop-up window, a visual representation 212 of the expiry presentation can be activated. If no user interaction by the user of the vehicle using a button takes place before the expiry of the expiry presentation, the pop-up window containing the proactive message is removed in an automated manner.

Advantageously, the method uses gaze-direction recognition by the vehicle to remove one or more proactive messages and one or more pop-up windows in an automated manner. This can ensure that the user has seen the pop-up window and/or the proactive message of the pop-up window but is not compelled to respond to the proactive message and/or to interact with the pop-up window. The acceptance of a proactive message and/or a pop-up window for providing a proactive message to the user can hence be improved efficiently. The user can remove a pop-up window more easily. The operation of the user interface can be improved efficiently.

### LIST OF REFERENCE SIGNS

100 method
102 receive a trigger event
104 provide a proactive message
106 detect a gaze direction
108 activate an expiry presentation
110 remove a proactive message
112 determine a display validity
114 remove a proactive message
200 graphical user interface
202 proactive message
204 visual representation of a digital voice assistant
206 pop-up window
208 button
210 button
212 visual representation of an expiry presentation

1-13. (canceled)

14. A method for controlling a display duration of a proactive message on a display device of a vehicle, said method comprising:
receiving a trigger event from the vehicle to provide the proactive message to a user of the vehicle;
providing the proactive message on the display device of the vehicle to the user of the vehicle;
detecting a gaze direction of the user of the vehicle by an interior camera of the vehicle after the proactive message is provided on the display device of the vehicle; and
when the detected gaze direction of the user is pointing towards a position of the proactive message on the display device of the vehicle:
activating an expiry presentation of the provided proactive message; and
removing the provided proactive message on the display device after the expiry presentation of the provided proactive message has expired.

15. The method as claimed in claim 14, wherein the proactive message is provided in a pop-up element and/or a pop-up window of a graphical user interface on the display device of the vehicle.

16. The method as claimed in claim 15, said method further comprising:
when the detected gaze direction of the user is not pointing towards the position of the provided proactive message on the display device of the vehicle:
determining a display validity of the provided proactive message; and
removing the provided proactive message on the display device after the display validity of the provided proactive message has expired.

17. The method as claimed in claim 16, said method further comprising:
when the detected gaze direction of the user is pointing towards a position of the proactive message on the display device of the vehicle:
determining a display validity of the provided proactive message before activating an expiry presentation;
activating the expiry presentation of the provided proactive message before the display validity of the provided proactive message has expired; and
removing the provided proactive message on the display device after the expiry presentation of the provided proactive message has expired, even when the display validity of the provided proactive message expired after the activation of the expiry presentation.

18. The method as claimed in claim 15, wherein the provided proactive message comprises a prompt to the user for user interaction or user input; and
wherein the user interaction or the user input by the user can be made as long as the provided proactive message is displayed on the display device.

19. The method as claimed in claim 18, wherein the expiry presentation comprises a specified timespan, and once it has elapsed, the provided proactive message on the display device is removed in an automated manner.

20. The method as claimed in claim 19, wherein the expiry presentation comprises an animated graphical element, which displays visually or audio-visually the specified timespan and/or the elapsing of the specified timespan; and
wherein the expiry presentation is displayed in the pop-up element and/or the pop-up window of the provided proactive message.

21. The method as claimed in claim 14, wherein the expiry presentation is provided in the gaze direction of the user of the vehicle and separately from the position of the provided proactive message on the display device of the vehicle.

22. The method as claimed in claim 14, wherein the proactive message is a time-critical message to the user of the vehicle from an intelligent digital assistant of the vehicle.

23. The method as claimed in claim 14, further comprising:
determining a display validity of the provided proactive message before activating an expiry presentation;
wherein the provided proactive message is representative of a notification about a current availability of a vehicle function and/or of a driver assistance function of the vehicle; and
wherein the display validity of the provided proactive message is representative of the current availability of the vehicle function and/or of the driver assistance function of the vehicle.

24. A non-transitory computer-readable medium for controlling a display duration of a proactive message on a display device of a vehicle, wherein the computer-readable medium comprises instructions which, when executed on a control unit causes the control unit to:
receive a trigger event from the vehicle to provide the proactive message to a user of the vehicle;
provide the proactive message on the display device of the vehicle to the user of the vehicle;
detect a gaze direction of the user of the vehicle by an interior camera of the vehicle after the proactive message is provided on the display device of the vehicle; and
when the detected gaze direction of the user is pointing towards a position of the proactive message on the display device of the vehicle:
activate an expiry presentation of the provided proactive message; and
remove the provided proactive message on the display device after the expiry presentation of the provided proactive message has expired.

25. The computer-readable medium as claimed in claim 24, wherein the proactive message is provided in a pop-up element and/or a pop-up window of a graphical user interface on the display device of the vehicle.

26. The computer-readable medium as claimed in claim 25, said computer-readable medium further comprising instructions which, when executed on the control unit causes the control unit to:
when the detected gaze direction of the user is not pointing towards the position of the provided proactive message on the display device of the vehicle:
determine display validity of the provided proactive message; and
remove the provided proactive message on the display device after the display validity of the provided proactive message has expired.

27. The computer-readable medium as claimed in claim 26, said computer-readable medium further comprising instructions which, when executed on the control unit causes the control unit to:
when the detected gaze direction of the user is pointing towards a position of the proactive message on the display device of the vehicle:
determine a display validity of the provided proactive message before activating an expiry presentation;
activate the expiry presentation of the provided proactive message before the display validity of the provided proactive message has expired; and
remove the provided proactive message on the display device after the expiry presentation of the provided proactive message has expired, even when the display validity of the provided proactive message expired after the activation of the expiry presentation.

28. The computer-readable medium as claimed in claim 25, wherein the provided proactive message comprises a prompt to the user for user interaction or user input; and
wherein the user interaction or the user input by the user can be made as long as the provided proactive message is displayed on the display device.

29. The computer-readable medium as claimed in claim 28, wherein the expiry presentation comprises a specified timespan, and once it has elapsed, the provided proactive message on the display device is removed in an automated manner.

30. The computer-readable medium as claimed in claim 29, wherein the expiry presentation comprises an animated graphical element, which displays visually or audio-visually the specified timespan and/or the elapsing of the specified timespan; and
wherein the expiry presentation is displayed in the pop-up element and/or the pop-up window of the provided proactive message.

31. The computer-readable medium as claimed in claim 24, wherein the expiry presentation is provided in the gaze direction of the user of the vehicle and separately from the position of the provided proactive message on the display device of the vehicle.

32. A vehicle comprising a system for controlling a display duration of a proactive message on a display device of the vehicle, the system comprising a control unit configured to:
receive a trigger event from the vehicle to provide the proactive message to a user of the vehicle;
provide the proactive message on the display device of the vehicle to the user of the vehicle;
detect a gaze direction of the user of the vehicle by an interior camera of the vehicle after the proactive message is provided on the display device of the vehicle; and
when the detected gaze direction of the user is pointing towards a position of the proactive message on the display device of the vehicle:
activate an expiry presentation of the provided proactive message; and
remove the provided proactive message on the display device after the expiry presentation of the provided proactive message has expired.
